(19) United States
(12) Patent Application Publication
(10) Pub. No.: US 2004/0039935 A1
(43) Pub. Date: Feb. 26, 2004

(54) Method and device for measuring the execution time of a real task in a real time system

(76) Inventor: Manfred Pisecky, Wien (AT)

Correspondence Address: KENYON & KENYON, ONE BROADWAY, NEW YORK, NY, 10004, US

(21) Appl. No.: 10/333,035

(22) PCT Filed: Jul. 6, 2001
(86) PCT No.: PCT/DE01/02516

(30) Foreign Application Priority Data
Jul. 15, 2000 (DE) 10034459.3

(51) Int. Cl. H04L 9/00

(52) U.S. Cl. 713/200

(57) ABSTRACT

The method for measuring the run time of a task in a real-time system having a number of tasks provides that the timer is started at the beginning of the task whose run time is to be determined, and the timer is stopped in response to an interrupt, the timer status is stored, and, following termination of the interrupt, the timer is started again. The essence of the present invention is that the timer can be started at the beginning of each task, and its status is stored in response to each change in priority level.

The device according to the present invention for measuring the run time has one timer, which is provided with a memory having a capacity that is adapted to the number of priority levels.

### BACKGROUND INFORMATION

The present invention relates to a method and a device for measuring the run time of a task in a real-time system, in particular, in a real-time operating system. Examples of typical real-time operating systems are RCOS or ERCOS.

A task is understood to be an executable program part within a real-time system. The sum of all tasks yields the total real-time system. One also spekas then of a multitasking system. A real-time system is a computer program which is subject to strict requirements regarding its time response. Thus, the program must react to specific events within a specified time span. Real-time systems and especially real-time operating systems, are used predominantly in systems that are critical to safety.

To assure the desired time response of the entire system, it is important that each task contain specific time defaults. In this context, the tasks in a real-time system have different time requirements, so-called deadlines. The latter represent different priorities. It is assumed that tasks of a higher priority can interrupt those of a lower priority. This means that as soon as a higher-order task is to be executed, it interrupts the execution of a lower-order task.

To determine the time response of the entire system and, if necessary, to modify it, the run time of each specific task must be measured in the course of program development, in the testing phase, and also during the operation of the entire system, especially in response to later changes in the program.

It is known to determine the run time of a task manually. This is carried out, for example, using a CPU emulator. In this context, the problem arises that while the run time of one task is being measured, this task can be interrupted by a higher-priority task (preemptive multitasking). The measured time is invalid, since it is no longer the run time of one specific task that is being measured. In addition, manual measurement is very time-consuming. It increases the costs and time entailed in program development.

A further known method for measuring the run time of a task provides for a timer to also run in each task. A high-resolution hardware timer can be used as a timer, for example. However, a purely software solution is also conceivable. In this context, the increments of the timer must be much smaller than the customary task run times. In this way, even though it is assured that the time measurement will always start at the beginning of the task, it is still only possible, using this method, to measure the gross run time of the task, i.e., the actual run time, or the net run time of the task plus the interruptions by higher-order tasks. It may be that this method is less work-intensive than the manual method described above, but the results obtained are not much more precise. Therefore, there is no significant advantage over the manual method.

From European Patent 0 534 884 A1, a method is known for checking the time response of a multitasking system. The method provides for measuring the run time of individual tasks and for triggering an alarm in the event that a specifiable time duration is exceeded. The time duration is determined using a timer, or a counter. In this context, the time duration is determined as a multiple of the cycle of the processor. The multitasking system has a number of tasks, all of which are assigned a specific priority. Thus, it can happen that a lower-order task is interrupted by a higher-order task. To assure that the overall program observes the necessary time requirements, it is necessary that the run time of each individual task be able to be determined.

The counter is started at the beginning of the execution of a task whose run time is to be determined in processor cycles. The counter begins at a specifiable value and decreases its status after each cycle. If a defined lower limit is reached, then an alarm signal is output. If the task is interrupted by a higher-priority task, the counter is stopped and the current status is stored. Following termination of the interrupt, the counter is started once again, beginning with the stored status.

A disadvantage of the method described in European Patent 0 534 884 A1 is that the run time of a task can only be measured during one measuring operation. Not until the run time of the task is determined, i.e., the task is terminated, can the counter be used to determine the run time of a further task. A measuring operation starts at the beginning of the execution of a task and at its termination.

The object of the present invention is, therefore, to devise a method and a device which will enable the run time of a task to be precisely measured and, moreover the run times of a plurality of tasks to be determined in one measuring operation.

The objective is achieved, with respect to the method, by a method having the features of claim 1.

The objective is achieved, with respect to the device, by a device having the features of claim 6.

Advantageous embodiments of the present invention are derived from the dependent claims.

### ADVANTAGES OF THE INVENTION

The method according to the present invention measures the run time of a task in a real-time system having a number of tasks, which are assigned, at least partially, to different priority levels. In this context, the individual tasks can all be executed on different priority levels. However, a few or even all of the tasks may be executed on the same priority level, or levels. To measure the run time, a timer is provided whose status represents the run time. The timer is started at the beginning of a task whose run time is to be determined. If the task interrupted by a higher-priority task, i.e., if there is a change in the priority level, then the timer is stopped and the current status is stored. Following termination of the interrupt, i.e., as soon as the task whose run time is to be determined, is once again running, the stored status of the timer is restored, and the timer is started again, beginning at the stored status.

It is advantageous that the timer status is stored as early as possible in response to an interruption of a first task, and following termination of the interrupt, that it is restored as late as possible, i.e., as immediately as possible before the restart of the task. On the basis of this measure, especially precise measurements of the net run times of a task are possible. This has proven to be advantageous because a systematic measuring error cannot be ruled out, since a portion of the priority change is included in the measurement until the timer status is saved. The same applies to restoring a stored timer status. Because the timer status is stored as quickly as possible in response to an interrupt and is restored as late as possible following termination of the interrupt, this error is able to be minimized. In any case, this measuring error is substantially smaller than the measuring error in measuring the gross run time.

According to one preferred embodiment of the method according to the present invention, in the event of an interruption of the first task by a higher-priority second task, the run time of the second task is measured during the interruption of the run time of the first task. Of course, in this context, it is possible during the corresponding interrupts of the second task to measure the run time of a third task, etc. In accordance with the present invention, it is therefore possible, basically during one cycle of a real-time system, to measure tasks as they arise essentially simultaneously.

As a result, as was already mentioned, because the time measurement is always started at the beginning of a task and is stopped during an interrupt, the net run time of the task, or tasks, is determined.

It advantageous that only one timer be provided for all priority levels. Within one priority level, all tasks run in a cooperative manner, i.e., they do not interrupt each other. In response to a change in the priority level, for example, at the beginning of a higher-order task, the status of the CPU used is saved so that the CPU is in the same status after the end of the interrupt as before the interrupt. In addition, the status of the timer is saved in response to every priority change. Thus, using one timer, it is possible in one measuring operation to determine the run times of a plurality of tasks that run on different priority levels.

Using the method according to the present invention, the net run times of all tasks in the system can be measured more easily than heretofore. The additional expense derives from starting the measurement at the beginning of each task and from saving and restoring the timer in response to each change in priority. In this context, all interrupts by other tasks are automatically factored out. An improved and simpler monitoring of the system resource run time is therefore possible. The method is independent of the operating system and hardware that are used. The demand on resources regarding timers for the measurement is independent of the number of priority levels, because only one single timer is required. For each priority level, it is only necessary to make space available for saving the status of the measurement. This is essential for implementation, because the number of available timers is usually far more limited than the available storage space.

The device according to the present invention, for measuring the run time of a task in a real-time system that has a plurality of tasks of which each is executed on a specific priority level, has a timer. Furthermore, means are provided which enable the timer to start and stop. The timer is provided with a memory having a capacity that is adapted to the number of priority levels.

The device for measuring the run time is preferably a hardware timer. It can be already implemented in the CPU.

Advantageously, the increments of the timer are much smaller than the typical run time of the tasks. The smaller the increments, the more precise are the results of the measurements.

The present invention is discussed in greater detail on the basis of the attached drawing, whose figures show:

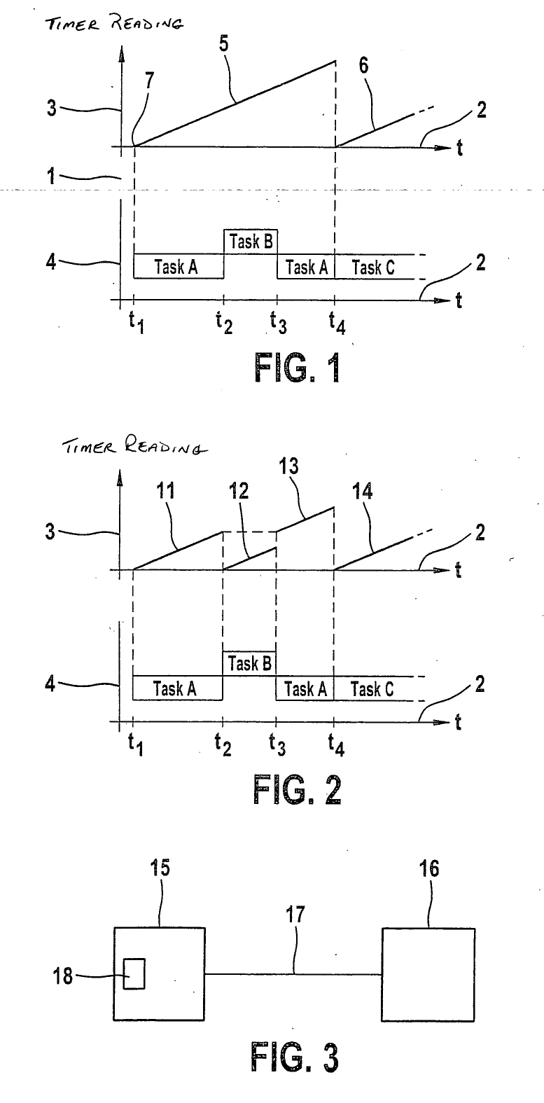

FIG. 1 the time curve of a timer status in a conventional method;

FIG. 2 the time curve of a timer status in the method according to the present invention;

FIG. 3 a device according to the present invention in a schematic representation.

FIG. 1 shows the time curve of a timer status in a conventional method. As can be seen, graph 1 has two x-axes 2 and a first y-axis 3 and a second y-axis 4. Time is plotted on both x-axes 2. Using first y-axis 3 it is possible to determine the status of the timer. Second y-axis 4 shows the priority levels on which the tasks run. A first straight line 5 and a second straight line 6 indicate the time curve of the status of the timer.

Task A begins at time point t₁. Its priority level can be derived from second y-axis 4. The timer is also started at time point t₁. First straight line 5 illustrates the change in the status of the timer through time. At time point 8, task A is interrupted by higher-order task B. The latter runs on a higher priority level. The change in the status of the timer over time is not influenced thereby, as first straight line 5 indicates. Task B stops at time point t₃. After the termination of the interrupt, task A continues. Task A terminates at time point t₄. The timer is stopped. The status of the timer can be read off of the first y-axis 3. Nevertheless, the measured value does not represent the net run time but rather the gross run time of task A. After the termination of task A, the status of the timer is reset. Task C begins, which runs in the same priority level as task A. The timer is once again started. In this context, second straight line 6 represents the status of the timer.

FIG. 2 depicts graph 1 from FIG. 1, representing the time curve of a timer status in the method according to the present invention. The temporal sequence of tasks A, B, and C corresponds to the sequence in FIG. 1. A third straight line 11, a fourth straight line 12, a fifth straight line 13, and a sixth straight line 14 represent the characteristic curve of the status of the timer.

Once again, task A begins at time point t₁. The timer is started. The status changes over time corresponding to third straight line 11. Task B starts at time point t₂. Task A is interrupted. The status of the timer is stored and subsequently reset. During the run time of task B, fourth straight line 12 represents the status of the timer. After the termination of task B at time point t₃, it is possible using first y-axis 3 to determine the status of the timer and thus the run time of task B. After the termination of task B at time point t₃, task A runs once again, as depicted by fifth straight line 13. The status that is stored at time point t₂ is restored, so that the timer runs once again beginning at the stored status. After the termination of task A at time point t₄, the status of the timer can be read off of first y-axis 3. This status is a measure for the net run time of task A. After the termination of task A, task C begins. The latter runs on the same priority level as task A and therefore could not, cannot, interrupt the latter's execution. Sixth straight line 14 represents the curve of the status of the timer.

FIG. 3 in a schematic representation depicts a device according to the present invention for measuring the run time of a task. The device has a timer 15 and a memory 16, which are connected to each other by a data line 17. Via data line 17, it is possible for timer 15 to store its status in memory 16. In timer 15, means 18 are provided, which make it possible to start and stop timer 15.

What is claimed is:

1. A method for measuring the run time of at least one task in a real-time system having a number of tasks, using at least one timer (15), the timer (15) being started at the beginning of a first task to be measured, and the status of the timer (15) being stored in the event of an interruption of the first task, and the stored status of the timer (15) being restored in response to a continuation of the first task, and the timer (15) being started again, starting from this stored status.

2. The method as recited in claim 1,
wherein, in response to an interruption of the first task, the status of the at least one timer (15) is stored as early as possible, and following termination of the interrupt, it is restored as late as possible.

3. The method as recited in one of claims 1 or 2,
wherein, in the event of an interruption of the first task due to a higher priority second task, the run time of the second task is measured during the interruption of the run time of the first task.

4. The method as recited in one of the preceding claims,
wherein all of the run time measurements of all tasks are carried out using precisely one timer, whose memory capacity is adapted to the number of different priority levels of the tasks.

5. A device for measuring the run time of at least one task in a real-time system having a number of tasks, comprising at least one timer (15) and means (18) for starting and stopping the timer (15),
wherein the timer (15) has assigned to it a memory (16) having a memory capacity which is adapted to the number of priority levels of the tasks.

6. The device as recited in claim 5,
wherein the timer is a hardware timer.

7. The device as recited in one of claims 5 or 6,
wherein the increment of the timer (15) is substantially smaller than the customary run time of the tasks.
